(19) United States
(12) Patent Application Publication
(10) Pub. No.: US 2023/0325181 A1
(43) Pub. Date: Oct. 12, 2023

(54) Code Analysis Method and Related Device

(71) Applicant: Huawei Cloud Computing Technologies Co., Ltd., Guizhou (CN)

(72) Inventors: Zhao Wei, Gui'an (CN); Guangtai Liang, Beijing (CN)

(21) Appl. No.: 18/335,538

(22) Filed: Jun. 15, 2023

Related U.S. Application Data
(63) Continuation of application No. PCT/CN2021/133166, filed on Nov. 25, 2021.

(30) Foreign Application Priority Data
Dec. 16, 2020 (CN) 202011491105.3

(51) Int. Cl. G06F 8/71

(52) U.S. Cl. CPC G06F 8/71

(57) ABSTRACT

A server obtains identity information of a changed file and a location of a changed code block in the changed file, where the changed code block is located in a terminal of a distributed system, and the distributed system includes a plurality of terminals configured to provide code compilation. The server determines a base version of the changed file based on the identity information of the changed file. The server further determines, based on the location of the changed code block in the changed file, whether the base version of the changed file includes a target code block that overlaps the location of the changed code block, and warns at least one terminal in the distributed system if the base version includes the target code block. In the foregoing method, the warning may be executed in time when it is determined that a code block has been modified.

### CROSS-REFERENCE TO RELATED APPLICATIONS

This is a continuation of International Patent Application No. PCT/CN2021/133166 filed on Nov. 25, 2021, which claims priority to Chinese Patent Application No. 202011491105.3 filed on Dec. 16, 2020. The disclosures of the aforementioned applications are hereby incorporated by reference in their entireties.

### TECHNICAL FIELD

This disclosure relates to the field of software development technologies, and more specifically, to a code analysis method and a related device.

### BACKGROUND

Currently, programs are developed based on a distributed environment through multi-user collaboration. During collaborative development, programmers develop code separately and do not synchronize the code with a trunk and branches for a long time, bringing accumulation of a large amount of conflicts, and bringing great inconvenience to combination and resolution for a later version.

To resolve this problem, a method for detecting code conflicts based on artificial intelligence (AI) is proposed in the industry. The method trains a random forest binary classification model, collects some information in the code (for example, a quantity of files that is changed accordingly, a quantity of committed codes between earlier and latest committed codes, and a quantity of files added, deleted, renamed, modified, and copied in a branch), and determines, based on the collected information and the trained random forest model, whether the combination of two branches causes conflicts.

However, this method is undesirable in actual application, hardly applicable to actual scenarios.

### SUMMARY

This disclosure provides a code analysis method and a related device, which may help developers quickly find modified code, and further determine whether the modified code affects compiled programs.

According to a first aspect, embodiments of this disclosure provide a code block processing method, including: obtaining attribute information of a changed code block, where the attribute information of the changed code block includes identity information of a changed file and a location of the changed code block in the changed file, the changed code block is located in a terminal of a distributed system, and the distributed system includes a plurality of terminals configured to provide code compilation; determining a base version of the changed file based on the identity information of the changed file; determining, based on the location of the changed code block in the changed file, whether the base version of the changed file includes a target code block that overlaps the location of the changed code block; and if the base version of the changed file includes the target code block, warning at least one terminal in the distributed system.

In the foregoing technical solution, if a location of a code block being compiled (that is, the changed code block) overlaps a location of a code block that has been compiled (that is, the target code block), the terminal is warned, so that a programmer (referred to as a programmer A) learns that a code block has been modified by another programmer (referred to as a programmer B). In this way, the programmer A may determine whether a changed code block affects other parts of the code, and determine how to handle the changed code block based on a determination result. For example, if the changed code block does not affect other parts of the code, the programmer A may retain the changed code block; if the changed code block affects other parts of the code, the programmer A may communicate with the programmer B to determine whether it is necessary to cancel the modification of the code block or evaluate whether to modify an affected part of the code.

Objects for the warning may be all terminals that participate in code development in the distributed system, allowing all the participants to learn about a modification status of the code.

Objects for the warning may alternatively be a part of terminals in the distributed system. For example, the terminal may be a terminal of an author of the target code block. For another example, the terminals may be terminals used by all authors that participate in compiling the changed file.

The modification of a warning target code block may be prompted by using a pop-up window, or may be prompted by using a fixed prompt window in an integrated development environment (IDE). In warning content, all content of the changed code block may be presented, or only location information of the changed code block is presented and all content of the changed code is presented when the warning content is selected. In addition, a difference between the changed code block and the target code block may be highlighted.

With reference to the first aspect, in a possible implementation, the warning the terminal in the distributed system includes: storing the changed code block to a conflict list of changed code; and pushing the conflict list of changed code to the at least one terminal in the distributed system.

In the foregoing technical solution, a conflicting code block is stored in a list manner. In this way, when there is a plurality of code blocks conflicting, a conflicting code block may be more intuitively determined.

With reference to the first aspect, in a possible implementation, the attribute information of the changed code block further includes an author of the changed code block; warning the terminal in the distributed system if the base version includes the target code block includes: determining that the author of the changed code block is different from an author of the target code block, and sending first warning information to a first target terminal in the distributed system, where the first target terminal is a terminal used by the author of the target code block, and the first warning information indicates that the target code block is modified.

In the foregoing technical solution, it is further determined whether the code block is modified by an original author of the code block. If the code is not modified by the original author, remind the original author that the code block is modified by another programmer. In this way, the original author may learn a latest status of the code. In addition, because an author of an original code block (that is, the target code block) is more familiar with the target code block, the original author can more quickly determine whether a problem occurs when another programmer modifies the code block, and/or whether another part of the code is affected.

With reference to the first aspect, in a possible implementation, the method further includes: determining whether the target code block overlaps a location of a particular code block in a code analysis library, where the particular code block includes a code block for defining a function or a code block for defining a variable; and sending, if the target code block overlaps the particular code block, second warning information to a second target terminal in the distributed system, where code compiled by the second target terminal includes a function or a variable defined by the particular code block, and the second warning information indicates that the function or the variable defined by the particular code block changes.

If a function or variable is faulty, the entire code may be greatly affected. Therefore, in the foregoing technical solution, when a code block for defining a function or a variable is modified, an author who writes the function or the variable may be reminded that the function or the variable compiled by the author changes. In this way, an original author of a function or a variable may easily master a latest status of the code. In addition, because an author of an original code block (that is, the target code block) is more familiar with the target code block, the original author can more quickly determine whether a problem occurs when another programmer modifies the code block, and/or whether another part of the code is affected.

With reference to the first aspect, in a possible implementation, if the target code block overlaps the particular code block, the method further includes: analyzing the changed code block, and determining key information of a first object defined by the changed code block; determining key information of a second object defined by the target code block, where the first object and the second object are functions, or the first object and the second object are variables; comparing the key information of the first object with the key information of the second object, and determining difference information between the key information of the first object and the key information of the second object, where the second warning information further indicates the difference information.

In the foregoing technical solution, modified key information is determined by analyzing a code block. In this way, the key information may be indicated only to the original author of the code block. The original author may determine the key information that is modified more intuitively without spending extra time finding the location of the modified code.

With reference to the first aspect, in a possible implementation, if the first object and the second object are functions, the key information includes any one or more of the following information: a name of the function, a parameter in the function, a return value in the function, a start line of the function, an end line of the function, a class to which the function belongs, a file name of the class to which the function belongs, a function name of another function called by the function, a parameter in the another function, a start line of the another function, an end line of the another function, a class to which the another function belongs, a file name of the class to which the another function belongs, and a type name of an invoker that invokes the function; or if the first object and the second object are variables, the key information includes one or more of the following information: a name of the variable, a start line of the variable, an end line of the variable, a type of the variable, and a variable value.

With reference to the first aspect, in a possible implementation, the obtaining attribute information of a changed code block includes: obtaining the attribute information of the changed code block that is sent by a collection agent module of the terminal in the distributed system.

According to a second aspect, embodiments of this disclosure provide a computer device. The computer device includes units configured to implement any one of the first aspect or the possible implementations of the first aspect.

According to a third aspect, embodiments of this disclosure provide a computer device. The computer device includes a processor. The processor is coupled to a memory, and configured to read and execute instructions and/or program code in the memory, to perform the method according to any one of the first aspect or the possible implementations of the first aspect.

According to a fourth aspect, embodiments of this disclosure provide a computer program product. The computer program product includes computer program code. When the computer program code runs on a computer, the computer is enabled to perform the method according to any one of the first aspect or the possible implementations of the first aspect.

According to a fifth aspect, embodiments of this disclosure provide a computer-readable storage medium. The computer-readable storage medium stores program code. When the computer-readable storage medium runs on a computer, the computer performs the method according to any one of the first aspect or the possible implementations of the first aspect.

### BRIEF DESCRIPTION OF DRAWINGS

FIG. 1 is a schematic diagram of a system to which an embodiment of this disclosure is applied.

FIG. 2 is a schematic diagram of an implementation according to an embodiment of this disclosure.

FIG. 3 is a schematic diagram of a collection agent module.

FIG. 4 is a schematic flowchart of a code block processing method according to an embodiment of this disclosure.

FIG. 5 is a schematic block diagram of a structure of a computer device according to an embodiment of this disclosure.

FIG. 6 is a schematic block diagram of a structure of a computer device according to an embodiment of this disclosure.

### DESCRIPTION OF EMBODIMENTS

The following describes technical solutions of this disclosure with reference to accompanying drawings.

A “program” in embodiments of this disclosure may be software, a game, an application (app), a web page, or the like that is formed by developers by compiling code in a programming language.

A system architecture of a distributed development environment and commands or functions used to implement functions described in embodiments of this disclosure are described by using Git as an example. Git, which is a free and open source distributed version control system, uses a distributed version library without requiring server-side software for version control, facilitating source code release and communication.

It may be understood that, in addition to Git, the technical solutions of this disclosure may also be applied to other distributed version control systems capable of implementing same or similar functions as Git.

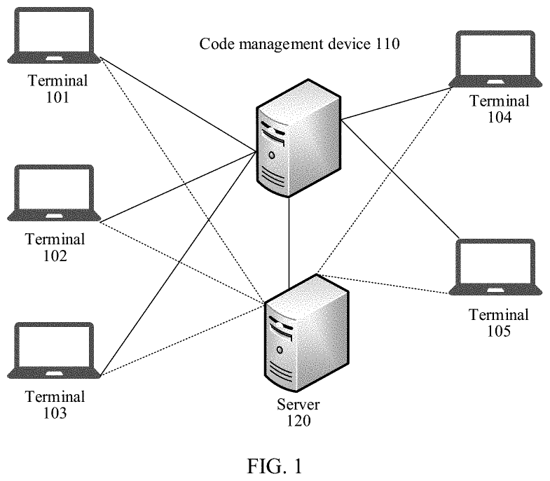

FIG. 1 is a schematic diagram of a system architecture applied to an embodiment of this disclosure. As shown in FIG. 1, the system 100 includes a terminal 101, a terminal 102, a terminal 103, a terminal 104, a terminal 105, a code management device 110, and a server 120.

The following briefly describes a collaborative development process in a distributed environment with reference to the system 100 shown in FIG. 1.

The code management device 110 stores a code repository (which may also be referred to as a code warehouse) in which code files of developed programs. Different programmers clone code files from the code repository in the code management device 110 to terminals through different terminals, and locally perform code compilation for files.

For example, assuming that a programmer 1 uses the terminal 101 for code compilation. In this case, all code files in the code repository in the code management device 110 may be cloned to the code repository of the terminal 101, and code compilation is performed on the terminal 101. Assuming that a programmer 2 uses the terminal 102 to perform code compilation. In this case, all code files in the code repository in the code management device 110 may be cloned to the code repository of the terminal 102, and code compilation is performed on the terminal 102; and other cases are similar by analogy.

The code management device 110 may be a device having a data storage function, or may be a server, a terminal, or a computer device in another form.

To distinguish a code repository in the terminal from a code repository in the code management device, the code repository in the terminal may be referred to as a local repository, and the code repository in the code management device may be referred to as a central code repository or a remote repository.

In addition to the local repository, the terminal further includes a work area and a cache area.

Code is compiled in the work area. The cache area is a place for storing a changed file added to the work area. The changed file may be further saved to the local repository and then pushed to the central code repository.

For example, the programmer 1 performs code compilation on a file 1 through the terminal 101. The programmer 1 modifies the file 1 in the work area (for example, adding new code to the file 1, deleting some code in the file 1, and/or modifying some code in the file 1) to obtain a changed file 1. For ease of distinguishing, a file 1 before the programmer 1 modifies the file 1 may be referred to as a file 1-a, and a changed file 1 is referred to as a file 1-b. In this case, a file 1 in the work area is a file 1-b, a file 1 in the local repository is a file 1-a, and a file 1 in the remote repository is also a file 1-a. The programmer 1 may store the file 1-b to the cache area through a git add command, then submit the file 1-b in the cache area to the local repository through a git commit command, and finally push the content in the local repository to the central code repository through a git push command. In this case, the file 1 in both the local repository and the central code repository is updated to the file 1-b. After that, if other programmers synchronize the central code repository, the file 1 in the local code repository after synchronization is the file 1-b.

A file may exist in a current version and a base version. The current version is a version in the work area. The base version is a previous version of the current version. The current version may be obtained by adding, deleting, or modifying code on the base version. The file 1 is further used as an example. The base version of the file 1 is the file 1-a, and the current version is the file 1-b.

The server 120 shown in FIG. 1 may perform code analysis to warn of a code conflict that may occur when each terminal writes code.

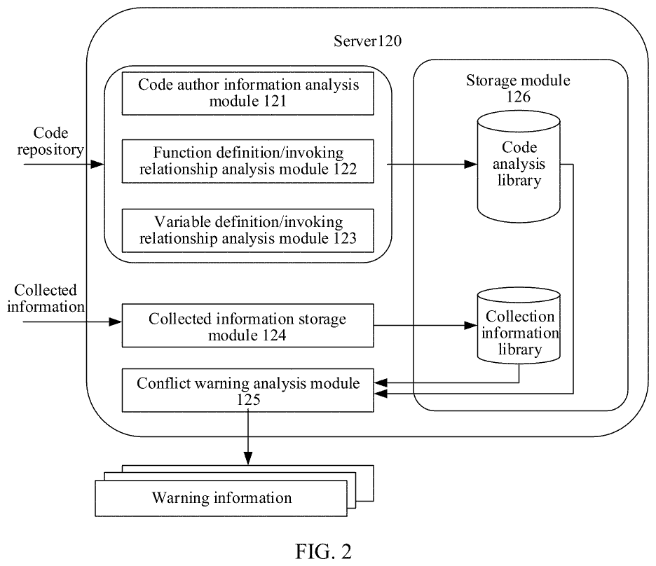

FIG. 2 is a schematic diagram of a structure of a server 120 shown in FIG. 1. As shown in FIG. 2, the server 120 includes a code author information analysis module 121, a function definition/invoking relationship analysis module 122, a variable definition/invoking relationship analysis module 123, a collected information storage module 124, a conflict warning analysis module 125, and a storage module 126.

The code author information analysis module 121 is configured to analyze code files in the central code repository (for example, by using a git blame command), determine author information of each code block in the code files, and store the author information of the code blocks in the code analysis library.

It should be understood that, in some embodiments, the central code repository may further be stored on the server 120 configured to perform code conflict warning, in other words, the server 120 both stores the code repository and performs the code conflict warning. In this case, the code author information analysis module 121 of the server 120 directly analyzes the code file in the local code repository.

In some other embodiments, the code repository may further be stored in another device or environment, for example, the code management device 110 shown in FIG. 1. In this case, the code author information analysis module 121 of the server 120 accesses the code repository in a remote access manner, and analyzes the code file in the code repository.

In some embodiments, code in a file may be compiled by a plurality of programmers. In this case, a segment of code compiled by each programmer has corresponding author information.

For example, the file 1 has a total of 20000 lines of code, where the 1^{st} line to the 5000th line are compiled by a programmer A, the 501^{st} line to the 15000^{th} line are compiled by a programmer B, and the 15001^{st} line to the 20000^{th} line are compiled by a programmer C. In this case, author information of three code blocks may exist.

In some other embodiments, code in a file may be compiled by a programmer. In this case, the file has the author information of the programmer.

In some other embodiments, code in a plurality of files may be compiled by a programmer. In this case, the plurality of files may have only one piece of author information, and the author information is author information of the programmer that writes the plurality of files.

In addition to identity information (for example, any one or more of an email address, a name of the author, or a mobile phone number of the author) of the author, the author information of the code block stored in the code analysis library may further include location information of code compiled by the author.

For example, assuming that the file 1 has a total of 20000 lines of code, where the 1^{st} line to the 5000^{th} line are compiled by the programmer A, the 501^{st} line to the 15000^{th} line are compiled by the programmer B, and the 15001^{st} line to the 20000^{th} line are compiled by the programmer C. The author information stored in the code analysis library may be:
[file 1; [1:5000]; ID A]; [file 1; [5001:15000]; ID B]; [file 1; [15001:20000]; ID C], where
[file 1; [1:5000]; ID A] indicates that an author ID of the Pt line to the 5000^{th} line of the file 1 is A; [file 1; [5001:15000]; ID B] indicates that an author ID of the 5001^{th} line to the 15000^{th} line of the file 1 is B; and [file 1; [15001:20000]; ID C] indicates that an author ID of the 15001^{th} line to the 20000^{th} line of the file 1 is C.

For another example, assuming that a file 2 is compiled by the programmer A, and a file 3 and a file 4 are compiled by the programmer B. In this case, author information stored in the code analysis library may be:
[file 2; ; ID A]; [file 3; ; ID B]; [file 4; ; ID C], where
[file 2; ; ID A] indicates that an author ID of the file 2 is A; [file 3; ; ID B] indicates that an author ID of the file 3 is B; and [file 4; ; ID C] indicates that an author ID of the file 4 is C.

For another example, assuming that the file 2 and the file 3 are compiled by the programmer A, and the file 4 and a file 5 are compiled by the programmer B. In this case, the author information stored in the code analysis library may be:
[file 2, file 3; ; ID A]; [file 4, file 5; ; ID B]; where
[file 2, file 3; ; ID A] indicates that author IDs of the file 2 and file 3 are A, and [file 4, file 5; ; ID B] indicates that author IDs of the file 4 and file 5 are B.

In some other embodiments, the author information may further include one or more of the following: a commit identifier (CommitID), a code repository ID (RepoID), or a project name (RepoName).

The function definition/invoking relationship analysis module 122 is configured to perform function relationship analysis on the code file in the central code repository, determine key information of the function, and store the determined key information of the function in the code analysis library.

Similarly, if the central code repository is stored on the server 120, the function definition/invoking relationship analysis module 122 may directly analyze the code file in the local code repository. If the central code repository is stored in the code management device 110, the function definition/invoking relationship analysis module 122 may access the code repository in a remote access manner, and analyze the code file in the code repository.

For example, the function definition/invoking relationship analysis module 122 may use a code parser (for example, jdt/cdt) to analyze the code file in the central code repository, obtain a corresponding function declaration and function invoking in each file, and record key information of the function. The recorded key information is stored in a function declaration list (FuncDeclList).

The key information of the function may include one or more of the following information: a name of the function, a parameter in the function, a return value in the function, location information of the function (for example, a start line and an end line of the function, a start line and an offset value of the function, or an end line and an offset value of the function), a class to which the function belongs, or a file name of the class to which the function belongs.

For another example, the function definition/invoking relationship analysis module 122 may further perform type analysis on an invoker that invokes the function, obtain a type name of the invoker, and store the type name in a function invoking list (FuncInvokeList). The type name of the invoker that invokes the function may also be used as the key information of the function.

For another example, the function definition/invoking relationship analysis module 122 may further traverse two lists FuncDeclList and FunclnvokeList respectively, determine a relationship between a function definition and a function invoking based on the function name, the parameter, and a function invoker type, and store the relationship in function declaration invoking matching information. The information may also be used as key information of the function.

For example, function B is invoked in function A. In this case, the function definition/invoking analysis module 122 may further obtain one or more of the following information as key information of the function A: a function name of the function B, a parameter of the function B, location information of the function B, a class to which the function B belongs, and a file name of the class to which the function B belongs. For another example, the function A invokes the function B, and the function B invokes function C. In this case, some related information (for example, one or more of a function name, a parameter, location information, a class to which the function belongs, and a file name of the class to which the function belongs) of the function C may also be used as key information of the function A. For ease of description, the foregoing information about the invoked function may be collectively referred to as invoked information.

In some embodiments, a depth of the invoked information may be set according to requirements. For example, assuming that the function A invokes the function B, the function B invokes the function C, and the function C invokes the function B. Assuming that the depth is 0, it may be unnecessary to determine related information (a function name, a parameter, location information, a class to which the function belongs, a file name of the class to which the function belongs, and the like) of the function B, the function C, and the function D as key information of the function A. Assuming that the depth is 1, the key information of the function A may include related information of the function B, and does not need to include related information of the function C and the function D. Assuming that the depth is 2, the key information of the function A may include related information of the function B and the function C, and does not need to include related information of the function D. Assuming that the depth is 3, the key information of the function A may include related information of the function B, the function C, and the function D.

The analysis result obtained by the function definition/invoking relationship analysis module 122 by analyzing the function, for example, key information of the function, a function declaration list, a function invoking list, and function declaration invoking matching information, are stored in the code analysis library.

The variable definition/invoking relationship analysis module 123 is configured to perform variable analysis on the code file in the central code repository, determine key information of the variable, and store the determined key information of the variable in the code analysis library.

Similarly, if the central code repository is stored on the server 120, the variable definition/invoking relationship analysis module 123 may directly analyze the code file in the local code repository. If the central code repository is stored in the code management device 110, the variable definition/invoking relationship analysis module 123 may access the code repository in a remote access manner and analyze the code file in the code repository.

The key information of the variable may include one or more of the following information: a name of the variable, location information of the variable (for example, a start line and an end line of the variable, a start line and an offset value of the variable, or an end line and an offset value of the variable), a type of the variable, or a variable value.

The key information of the function and the key information of the variable may be obtained by using an abstract syntax tree (AST).

The collected information storage module 124 may be configured to obtain attribute information of a changed code block, and store the attribute information of the changed code block into a collection information library.

The conflict warning analysis module 125 is configured to trigger conflict warning analysis periodically or based on a particular event, analyze whether content stored in the collection information library conflicts with content in the code analysis library, generate warning information, and send the generated warning information to a corresponding terminal.

The storage module 126 may be configured to store the code analysis library and the collection information library. If the central code repository is stored in the server 120, the storage module 126 may be further configured to store the code file in the central code repository.

In some embodiments, the content stored in the storage module 126 may further be kept in another storage device or storage system. For example, the code analysis library and/or collection information library may be stored in an object storage service (OBS) in the cloud.

Each terminal in the system 100 shown in FIG. 1 includes a collection agent module. The collection agent module collects code in a file being compiled; determines whether the code in the file being compiled changes with code of a corresponding file in a base version; and if the code changes, feeds back the change to the server 120.

The collection agent module may collect, according to a preset rule, code in the file being compiled.

In some embodiments, the preset rule may be collecting code in the file being compiled based on a time period.

For example, the collection agent module may be started when a program development application (for example, an IDE) starts or opens the file being compiled, and start a timer. The timer may have a preset time period. When the timer reaches the time period, the code in the file is collected, and the collected code is compared with the code in the corresponding file to determine whether the code changes.

In some other embodiments, the preset rule may be collecting, based on a quantity of lines, code in a file being compiled.

For example, the collection agent module may detect a quantity of modified code lines in the file being compiled, and if the quantity of modified code lines is equal to a preset line quantity threshold, collect code in the file, and compare the collected code with code in a corresponding file to determine whether the code changes.

For another example, the collection agent module may further collect code in the file when the file being compiled is closed, and compare the collected code with the code in a corresponding file to determine whether the code changes.

For another example, the programmer may further manually trigger the collection agent module to perform code collection and comparison. For example, the programmer may trigger, by entering an instruction or clicking an icon in the IDE, the agent collection module to collect code in a file, and compare the collected code with code in a corresponding file to determine whether a change occurs.

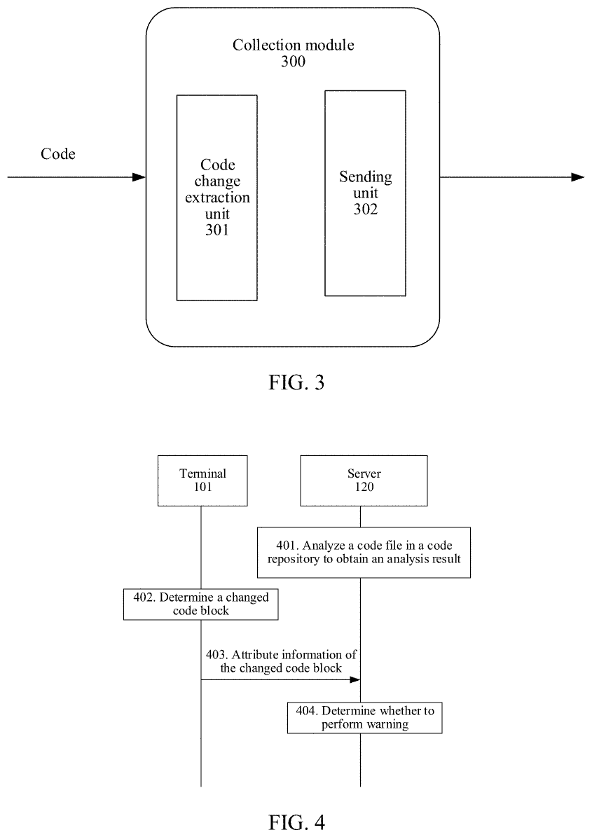

FIG. 3 is a schematic diagram of a collection agent module. As shown in FIG. 3, the collection agent module 300 may include a code change extraction unit 301 and a sending unit 302.

The code change extraction unit 301 in the collection agent module is configured to determine whether collected code changes.

The sending unit 302 is configured to send, when it is determined that the code changes, related information about the code change to the server 120.

FIG. 4 is a schematic flowchart of a code analysis method according to an embodiment of this disclosure. In embodiments shown in FIG. 4, assuming that the code repository of the terminal 101 stores base versions of three files, and file names are file A.go, file B.go, and file C.go. The work area of the terminal 101 has current versions of the three files, and the file names are file A.go, file B.go, and file C.go. To distinguish files in the base version from those in the current version, A_base indicates file A.go in the base version, B_base indicates file B.go in the base version, C_base indicates file C.go in the base version, A_curr indicates file A.go in the current version, B_cur indicates file B.go in the current version, and C_curr indicates file C.go in the current version.

Assuming that B_cur is being compiled. For ease of description, in the following, a file being compiled is referred to as a first target file, a file corresponding to the first target file in the base version is referred to as a second target file, and a changed code block is referred to as a changed code block. In this case, the first target file is B_cur, and the second target file is B_base.

Assuming that content of the second target file is as follows:

| 1 | package main |
|---|---|
| 2 | import ″fmt″ |
| 3 | func main( ) { |
| 4 | var a int = 21 |
| 5 | var b int = 10 |
| 6 | var c int |
| 7 | c = a + b |
| 8 | fmt.Printf(″The value of the first line - c is %d\n″, c ) |
| 9 | c = a − b |
| 10 | fmt.Printf(″The value of the second line - c is %d\n″, c ) |
| 11 | c = a * b |
| 12 | fmt.Printf(″The value of the third line - c is %d\n″, c ) |
| 13 | c = a / b |
| 14 | fmt.Printf(″The value of the fourth line - c is %d\n″, c ) |
| 15 | c = a % b |
| 16 | fmt.Printf(″The value of the fifth line - c is %d\n″, c ) |
| 17 | a++ |
| 18 | fmt.Printf(″The value of the sixth line - a is %d\n″, a ) |
| 19 | a=21 |
| 20 | a-- |
| 21 | fmt.Printf(″The value of the seventh line - a is %d\n″, a ) |
| 22 | } |
| Assuming that content of the first target file is as follows: | |
| 1 | package main |
| 2 | import ″fmt″ |
| 3 | func main( ) { |
| 4 | var a int = 11 |
| 5 | var b int = 2 |
| 6 | var c int |
| 7 | c = a + b |
| 8 | fmt.Printf(″The value of the first line - c is %d\n″, c ) |
| 9 | c = a - b |
| 10 | fmt.Printf(″The value of the second line - c is %d\n″, c ) |
| 11 | c = a * b |
| 12 | fmt.Printf(″The value of the third line - c is %d\n″, c ) |
| 13 | c = a / b |
| 14 | fmt.Printf(″The value of the fourth line - c is %d\n″, c ) |
| 15 | c = a % b |
| 16 | fmt.Printf(″The value of the fifth line - c is %d\n″, c ) |
| 17 | a++ |
| 18 | fmt.Printf(″The value of the sixth line - a is %d\n″, a ) |
| 19 | a=21 |
| 20 | a-- |
| 21 | fmt.Printf(″The value of the seventh line - a is %d\n″, a ) |
| 22 | } |

401. A server 120 analyzes a code file in a central code repository to obtain an analysis result. For a detailed analysis process of the code file by the server 120, refer to a related description in FIG. 2. For brevity, details are not described herein again.

402. A collection agent module 300 in a terminal 110 determines a changed code block.

For ease of description, the collection agent module 300 mentioned during describing embodiments shown in FIG. 4 is the collection agent module in the terminal 110.

The collection agent module 300 may determine, by comparing the first target file with the second target file, that the fourth line and the fifth line of code in the first target file are different from the fourth line and the fifth line of code in the second target file. Therefore, the collection agent module 300 may determine that the changed code block includes the fourth line and the fifth line of code in the first target file.

In addition, if a new line of code is inserted between the fourth line and the fifth line of the first target file, the changed code block determined by the collection agent module 300 includes the fifth line to the 22^{nd} line of code in the first target file.

Code in different files may be compared in an existing code comparison manner. For example, the diff function in Git may be used to compare the code in two files.

403. The collection agent module 300 feeds back attribute information of the changed code block to the server 120. The attribute information of the changed code block may include identity information of a changed file and a location of the changed code block in the changed file. The changed file is a file that includes the changed code block. The changed file in the foregoing example is the first target file.

The identity information of the changed file may include a file name of the changed file and path information for storing the changed file. In the foregoing example, the file name of the changed file is file B.go.

In some embodiments, the path information of the changed file may be a complete path of a folder storing the changed file in the terminal 110. For example, if the complete path of the file B.go in the terminal 110 is C:\Git\Study\Project 1\branch 1\file B.go, the complete path of the folder storing the file B.go is C:\Git\Study\Project 1\branch 1\, and the path information of the changed file may include the complete path.

In some other embodiments, the path information of the changed file may be a relative path of a folder storing the changed file. For example, if the complete path of the folder for storing the file B.go is C:\Git\Study\Project 1\branch 1\, all files in the code repository that includes the file B.go are stored in C:\Git\Study\Project 1. The complete path of the code file in the code repository may be divided into two parts: a public path and a relative path. All code files in the code repository are stored in the same public path, but the relative paths of different code files are different. For example, the complete path of the folder storing the file B.go file is C:\Git\Study\Project 1\branch 2\. It may be learned that the complete paths of the file A.go and the file B.go both include C:\Git\Study\Project 1. C:\Git\Study\Project 1 may be referred to as the public path. A relative path of the file A.go is branch 2\, and a relative path of the file B.go is branch 1\.

The identity information of the changed file includes the path information of the changed file, which can reduce a determining error caused by a file with a same name.

The location of the changed code block in the changed file may be indicated in different manners.

For example, the location of the changed code block in the changed file may be indicated by a start line and an end line of the changed code block. In this way, the location of the changed code block may be directly determined based on the start line and the end line. The first object file and the second object are further used as an example. If the start line and the end line indicate the location of the changed code block, the indication information may be [file B.go; C:\Git\Study\Project 1\branch 1\; 4:5]. [file B.go; C:\Git\Study\Project 1\branch 1\;4:5] indicates that the changed code block is in the fourth and fifth lines of the file B.go file in C:\Git\Study\Project 1\branch 1. It may be understood that, if the changed code has only one line, the start line and the end line in the indication information for indicating the location of the changed code block are the same.

For another example, a location of the changed code block in the changed file may be indicated by a start line and an offset value of the changed code block. A sum of the start line and offset value is the end line of the changed code block. In this way, the location of the changed code block may be determined by the start line and the offset value. The first object file and the second object are further used as an example. If the start line and the offset value indicate the location of the changed code block, the indication information may be [file B.go; C:\Git\Study\Project 1\branch 1\; 4, 1]. [file B.go; C:\Git\Study\Project 1\branch 1\file B.go; 4, 1] indicates that the changed code block is in the fourth line to the (4+1)th line in the file B.go file in C:\Git\Study\Project 1\branch 1. It may be understood that, if the changed code has only one line, an offset value in the indication information for indicating the location of the changed code block is 0.

For another example, the location of the changed code block in the changed file may further be indicated by an end line and an offset value of the changed code block. An indication manner of indicating the location of the changed code block by using the end line and the offset value is similar to an indication manner of indicating the location of the changed code block by using the start line and the offset value. For brevity, details are not described herein again.

It may be understood that a format of each piece of information in this embodiment of this disclosure is an example, but is not a specific limitation on the format.

In some embodiments, the attribute information of the changed code block may further include author information of the changed code block. The author information indicates the author of the changed code block. The author information of the changed code block may be identity information of the author, for example, any one or more of an email address, a name of the author, or a mobile phone number of the author.

For example, the information fed back by the collection agent module 300 to the server 120 may include the following content: DiffHunk={Hunk info: file B.go; C:\Git\Study\Project 1\branch 1\file B.go; HunkID: 1001; StartLine: 109; EndLine: 120; Version(Base/Current):1.01/1.02; Auther: ID A}. DiffHunk indicates the attribute information of the changed code block; Hunk info: file B.go; C:\Git\Study\Project 1\branch 1\file B.go; indicates that the identity information of the changed code block is the file B.go file in C:\Git\Study\Project 1\branch 1. HunkID: 1001 indicates that an identifier (ID) of the changed code block is 1001. StartLine: 109 indicates that a start line number of the changed code block is 109. EndLine: 120 indicates that an end line number of the changed code block is 120.

Version(Base/Current):1.01/1.02 indicates that a base version number is 1.01 and a current version number is 1.02. Auther: ID A indicates that an author ID of the changed code block is ID A.

In some other embodiments, the server 120 may determine the changed code block and the location and the author of the changed code block on its own. For example, if the collection agent module 300 finds that the content of the first target file is different from that of the second target file, the collection agent module 300 may directly send the first target file to the server 120. The server 120 stores a file in the base version or obtains, in a remote access manner, the base version file stored in the code management device 110. The server 120 may determine the second target file from the base version file based on the received first target file, and then determine the changed code block and the location of the changed code block based on the first target file and the second target file. In addition, the first target file carries the author information of the first target file. Therefore, the server 120 may further determine the author of the changed code block based on the author information of the first target file.

404. The server 120 obtains the attribute information of the changed code block, and determines whether to warn a terminal in the distributed system.

In some embodiments, the server 120 may determine whether the corresponding file (that is, the second object file) in the base version includes the target code block that overlaps the location of the changed code block.

The location overlapping may be that the changed code block is a subset of the second object file. In other words, both the start line quantity and the end line quantity of the changed code block are less than the maximum line quantity of the code in the second target file.

For example, the start line of the changed code block is the fourth line, and the end line is the fifth line. A total quantity of lines of the code in the second target file is 22. In this case, it may be determined that the second target file includes a target code block whose location overlaps the location of the changed code block.

The location overlapping may also be that an intersection exists between the target code block and the second target file. In other words, the start line quantity of the changed code block is less than the maximum line quantity of the code in the second target file, but the end line quantity of the changed code block may be greater than the maximum line quantity of the code in the second target file.

For example, the start line of the changed code block is line 932 and the end line is line 1016. A total quantity of lines of the code in the second target file is 1000. In this case, it may be determined that the second target file includes a target code block whose location overlaps the location of the changed code block.

In some embodiments, if it is determined that there are target code blocks whose locations overlap, the server 120 may push the warning to the terminal in the distributed system.

In some embodiments, the server 120 may store the changed code block in a conflict list of updated code, and push the conflict list of updated code to the terminal. In some other embodiments, the server 120 may store the location and/or the author of the changed code block into the conflict list of updated code, and push the conflict list of updated code to the terminal. In other words, in some embodiments, the conflict list of updated code includes code in the updated code block. In some other embodiments, the conflict list of updated code may include only the location and/or the author of the updated code block.

In some embodiments, the server 120 may push the conflict list of updated code to all terminals in the distributed system. In this way, all programmers participated in developing the software may learn that a piece of code is changed by a programmer.

In some other embodiments, the server 120 may compare the author of the updated code block with the author of the target code block. If the author of the updated code block is different from the author of the target code block, first warning information may be sent to a terminal (hereinafter referred to as a first target terminal) used by the author of the target code block to write code, and the first warning information indicates that the target code block is modified. The first warning information may include any one or more of code in the updated code block, or a location or an author of the updated code block. In this way, the author of the target code block may learn that the code compiled by the author is updated by another person.

In some other embodiments, the server 120 may determine, based on key information stored in the code analysis library, whether the updated code block overlaps the particular code block.

If the code analysis library stores only the key information of the function, the particular code block is a function in the code analysis library. If the code analysis library stores only the key information of the variable, the particular code block is a variable in the code analysis library. If the code analysis library stores the key information of the function and the key information of the variable, the particular code block is a function or variable in the code analysis library.

Similarly, whether the updated code block overlaps with the particular code block may be completely or partially overlapped.

For example, the updated code block is in line 719 to line 730 of the second object file. A file in which a class to which the function A belongs is a second target file, and the function A is in line 719 to line 730 in the second target file. Then, it may be determined that the updated code block overlaps the particular code block.

For another example, the updated code block is in line 719 to line 730 of the second target file. A file in which a class to which the function A belongs is a second target file, and the function A is in line 719 to line 830 in the second target file. Then, it may be determined that the updated code block overlaps the particular code block.

If the updated code block overlaps with the particular code block, it may be determined that an object (the function or the variable) defined by the particular code block is modified. In this case, the second warning information may be sent to a second target terminal in the distributed system, and the second warning information indicates that the function or the variable defined by the particular code block changes. The second target terminal may include a terminal whose code is compiled that includes the function or the variable defined by the particular code block. The second target terminal may further include a terminal that uses and/or cites the function or the variable defined by the particular code block.

In some embodiments, if the updated code block overlaps with the particular code block, the changed code block may be analyzed to obtain key information (hereinafter referred to as first key information) of an object defined by the changed code block; and key information (hereinafter referred to as second key information) of an object defined by the particular code block is obtained from the code analysis library. Difference information between the first key information and the second key information is compared, and the difference information is sent to the second target terminal.

For example, assuming that both the changed code block and the particular code block define a function, and the changed code block changes a function name of the defined function and adds a new return value. In this case, the difference information may include an updated function name and an added return value. In some embodiments, the difference information may further include a function name before update.

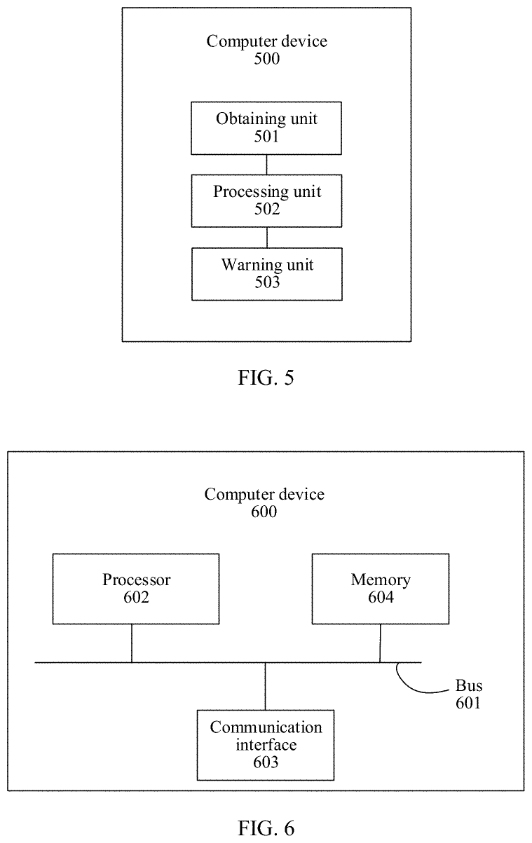

FIG. 5 is a schematic block diagram of a structure of a computer device according to an embodiment of this disclosure. The computer device shown in FIG. 5 may be a server 120 in a system 100 shown in FIG. 1. As shown in FIG. 5, the computer device 500 includes an obtaining unit 501, a processing unit 502, and a warning unit 503.

The obtaining unit 501 is configured to obtain attribute information of a changed code block, where the attribute information of the changed code block includes identity information of a changed file and a location of the changed code block in the changed file, the changed code block is located in a terminal of a distributed system, and the distributed system includes a plurality of terminals configured to provide code compilation.

The processing unit 502 is configured to determine a base version of the changed file based on the identity information of the changed file.

The processing unit 502 is further configured to determine, based on the location of the changed code block in the changed file, whether the base version of the changed file includes a target code block that overlaps the location of the changed code block.

The warning unit 503 is configured to warn at least one terminal in the distributed system if the processing unit 502 determines that the base version of the changed file includes the target code block.

For specific functions and beneficial effects of the obtaining unit 501, the processing unit 502, and the warning unit 503, reference may be made to the descriptions of the foregoing embodiments. For brevity, details are not described herein again.

FIG. 6 is a schematic block diagram of a structure of a computer device according to an embodiment of this disclosure. The computer device 600 includes a bus 601, a processor 602, a communication interface 603, and a memory 604. The processor 602, the memory 604, and the communication interface 603 communicate with each other through the bus 601. The processor 602 may be a field-programmable gate array (FPGA), an application-specific integrated circuit (ASIC), system on a chip (SoC), a central processor unit (CPU), a network processor (NP), a digital signal processor (DSP), a micro controller unit (MCU), a programmable logic device (PLD), another programmable logic device, a discrete gate or transistor logic device, a discrete hardware component, or another integrated chip. The memory 604 stores executable code included in a pathological image processing system. The processor 602 reads the executable code in the memory 604 to perform the method shown in the foregoing embodiment. The memory 604 may further include another software module, such as an operating system, required for running a process. The operating system may be LINUX™ UNIX™ WINDOWS™, or the like.

Embodiments of this disclosure further provides a chip system, including a logic circuit. The logic circuit is coupled to an input/output interface, and is configured to perform data transmission through the input/output interface, to perform the method shown in FIG. 4.

In an implementation process, steps in the foregoing methods can be implemented by using a hardware integrated logical circuit in the processor, or by using instructions in a form of software. The steps of the method disclosed with reference to embodiments of this disclosure may be directly performed by a hardware processor, or may be performed by using a combination of hardware in the processor and a software module. The software module may be located in a mature storage medium in the art, such as a RAM, a flash memory, a read-only memory, a programmable read-only memory, an electrically erasable programmable memory, or a register. The storage medium is located in the memory, and the processor reads information in the memory and completes the steps in the foregoing methods in combination with hardware of the processor. To avoid repetition, details are not described herein again.

It should be noted that, the processor in embodiments of this disclosure may be an integrated circuit chip, and has a signal processing capability. In an implementation process, steps in the foregoing method embodiments can be implemented by using a hardware integrated logical circuit in the processor, or by using instructions in a form of software. A general purpose processor may be a microprocessor, or the processor may be any processor, or the like. The steps of the methods disclosed with reference to embodiments of this disclosure may be directly executed and accomplished by using a hardware decoding processor, or may be executed and accomplished by using a combination of hardware and software modules in the decoding processor. The software module may be located in a mature storage medium in the art, such as a RAM, a flash memory, a read-only memory (ROM), a programmable read-only memory (PROM), an electrically erasable programmable memory, or a register. The storage medium is located in the memory, and the processor reads information in the memory and completes the steps in the foregoing methods in combination with hardware of the processor.

It may be understood that the memory in this embodiment of this disclosure may be a volatile memory or a nonvolatile memory, or may include a volatile memory and a nonvolatile memory. The nonvolatile memory may be a ROM, a PROM, an erasable programmable read-only memory (EPROM), an electrically erasable programmable read-only memory (EEPROM), or a flash memory. The volatile memory may be a RAM that is used as an external cache. Through example but not limitative description, many forms of RAMs may be used, for example, a static random-access memory (SRAM), a dynamic random-access memory (DRAM), a synchronous dynamic random-access memory (SDRAM), a double data rate synchronous dynamic random-access memory (DDR SDRAM), an enhanced synchronous dynamic random-access memory (ESDRAM), a synchronous link dynamic random-access memory (SLDRAM), and a direct Rambus dynamic random-access memory (DR RAM). It should be noted that the memories of the system and method described herein are intended to include, but are not limited to, these and any other suitable types of memories.

According to the method provided in embodiments of this disclosure, this disclosure further provides a computer program product. The computer program product includes computer program code. When the computer program code is run on a computer, the computer is enabled to perform the method in the embodiment shown in FIG. 4.

According to the method provided in embodiments of this disclosure, this disclosure further provides a computer-readable medium. The computer-readable medium stores program code. When the program code is run on a computer, the computer is enabled to perform the method in the embodiment shown in FIG. 4.

A person of ordinary skill in the art may be aware that, in combination with the examples described in embodiments disclosed in this specification, units and algorithm steps may be implemented by electronic hardware or a combination of computer software and electronic hardware. Whether the functions are executed in a mode of hardware or software depends on particular applications and design constraint conditions of the technical solutions. A person skilled in the art may use different methods to implement the described functions for each particular application, but it should not be considered that the implementation goes beyond the scope of this disclosure.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this disclosure, it should be understood that the disclosed system, apparatus, and method may be implemented in other manners. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, in other words, may be located in one location, or may be distributed on a plurality of network units. Some or all of the units may be selected based on actual requirements to achieve the objectives of solutions of embodiments.

In addition, functional units in embodiments of this disclosure may be integrated into one processing unit, each of the units may exist alone physically, or two or more units may be integrated into one unit.

When the functions are implemented in a form of a software functional unit and sold or used as an independent product, the functions may be stored in a computer-readable storage medium. Based on such an understanding, the technical solutions of this disclosure essentially, or the part contributing to the other technologies, or some of the technical solutions may be implemented in a form of a software product. The computer software product is stored in a storage medium, and includes several instructions for instructing a computer device (which may be a personal computer, a server, or a network device) to perform all or some of the steps of the methods in embodiments of this disclosure. The foregoing storage medium includes any medium that can store program code, such as a Universal Serial Bus (USB) flash drive, a removable hard disk, a ROM, a RAM, a magnetic disk, or an optical disc.

The foregoing descriptions are merely specific implementations of this disclosure, but are not intended to limit the protection scope of this disclosure. Any variation or replacement readily figured out by a person skilled in the art within the technical scope disclosed in this disclosure shall fall within the protection scope of this disclosure. Therefore, the protection scope of this disclosure shall be subject to the protection scope of the claims.

What is claimed is:

1. A method, comprising:
obtaining attribute information of a changed code block, wherein the attribute information comprises identity information of a changed file and a first location of the changed code block in the changed file, wherein the changed code block is located in a terminal of a distributed system, and wherein the distributed system comprises a plurality of terminals;
determining, based on the identity information, a base version of the changed file;
determining, based on the first location, whether the base version comprises a target code block that overlaps the first location; and
warning at least one of the plurality of terminals when the base version comprises the target code block.

2. The method of claim 1, wherein warning the at least one of the plurality of terminals comprises:
storing, in a conflict list of changed code, the changed code block; and
pushing, to the at least one of the plurality of terminals, the conflict list.

3. The method of claim 1, wherein the attribute information further comprises a first author of the changed code block, wherein warning the at least one of the plurality of terminals comprises:
determining that the first author is different from a second author of the target code block; and
sending, to a first target terminal in the distributed system, first warning information,
wherein the first target terminal is used by the second author, and
wherein the first warning information indicates that the target code block is modified.

4. The method of claim 1, further comprising:
determining whether the target code block overlaps a second location of a particular code block in a code analysis library, wherein the particular code block is for defining a function or a variable; and
sending, when the target code block overlaps the second location, second warning information to a second target terminal in the distributed system,
wherein code compiled by the second target terminal comprises the function or the variable, and
wherein the second warning information indicates that the function or the variable changes.

5. The method of claim 4, wherein when the target code block overlaps the second location, the method further comprises:
analyzing the changed code block to determine first key information of a first object defined by the changed code block;
determining second key information of a second object defined by the target code block, wherein the first object and the second object are functions or variables; and
comparing the first key information with the second key information to determine difference information between the first key information and the second key information, and
wherein the second warning information further indicates the difference information.

6. The method of claim 5, wherein when the first object and the second object are the functions, the first key information and the second key information comprise a first name of the functions, a first parameter in the functions, a return value in the functions, a first start line of the functions, a first end line of the functions, a first class to which the functions belong, a first file name of the first class, a function name of another function called by the functions, a second parameter in the other function, a second start line of the other function, a second end line of the other function, a second class to which the other function belongs, a second file name of the second class, or a type name of an invoker that invokes the other function, or when the first object and the second object are the variables, the first key information and the second key information comprise a second name of the variables, a third start line of the variables, a third end line of the variables, or a type of the variables.

7. The method of claim 1, wherein obtaining the attribute information comprises obtaining the attribute information of the changed code block that is from a collection agent module of the terminal.

8. An apparatus, comprising:
a memory configured to store instructions; and
one or more processors coupled to the memory and configured to execute the instructions to:
obtain attribute information of a changed code block, wherein the attribute information comprises identity information of a changed file and a first location of the changed code block in the changed file, wherein the changed code block is located in a terminal of a distributed system, and wherein the distributed system comprises a plurality of terminals;
determine, based on the identity information, a base version of the changed file;
determine, based on the first location, whether the base version comprises a target code block that overlaps the first location; and
warn at least one of the plurality of terminals when the base version comprises the target code block.

9. The apparatus of claim 8, wherein the one or more processors are further configured to execute the instructions to:
store, in a conflict list of changed code, the changed code block; and
push, to the at least one of the plurality of terminals, the conflict list.

10. The apparatus of claim 8, wherein the attribute information further comprises a first author of the changed code block, wherein the one or more processors are further configured to execute the instructions to:
determine whether the first author is the same as a second author of the target code block; and
send, to a first target terminal in the distributed system, first warning information when the first author is different from the second author,
wherein the first target terminal is used by the second author, and
wherein the first warning information indicates that the target code block is modified.

11. The apparatus of claim 10, wherein the one or more processors are further configured to execute the instructions to:
determine, when the first author is different from the second author, whether the target code block overlaps a second location of a particular code block in a code analysis library, wherein the particular code block is for defining a function or a variable; and
send, when the target code block overlaps the second location, second warning information to a second target terminal in the distributed system,
wherein code compiled by the second target terminal comprises the function or the variable, and
wherein the second warning information indicates that the function or the variable changes.

12. The apparatus of claim 11, wherein the one or more processors are further configured to execute the instructions to:
analyze, when the target code block overlaps the second location, the changed code block to determine first key information of a first object defined by the changed code block;
determine second key information of a second object defined by the target code block, wherein the first object and the second object are functions or variables; and
compare the first key information with the second key information to determine difference information between the first key information and the second key information, and
wherein the second warning information further indicates the difference information.

13. The apparatus of claim 12, wherein when the first object and the second object are the functions, the first key information and the second key information comprise a first name of the functions, a first parameter in the functions, a return value in the functions, a first start line of the functions, a first end line of the functions, a first class to which the functions belong, a first file name of the first class, a function name of another function called by the functions, a second parameter in the other function, a second start line of the other function, a second end line of the other function, a second class to which the other function belongs, a second file name of the second class, or a type name of an invoker that invokes the other function, or when the first object and the second object are the variables, the first key information and the second key information comprise a second name of the variables, a third start line of the variables, a third end line of the variables, a type of the variables, or a variable value.

14. The apparatus of claim 8, wherein the one or more processors are further configured to obtain the attribute information of the changed code block that is from a collection agent module of the terminal.

15. A computer program product comprising instructions stored on a non-transitory computer-readable medium that, when executed by one or more processors, cause an apparatus to:
obtain attribute information of a changed code block, wherein the attribute information comprises identity information of a changed file and a first location of the changed code block in the changed file, wherein the changed code block is located in a terminal of a distributed system, and wherein the distributed system comprises a plurality of terminals;
determine, based on the identity information, a base version of the changed file;
determine, based on the first location, whether the base version comprises a target code block that overlaps the first location; and
warn at least one of the plurality of terminals when the base version comprises the target code block.

16. The computer program product of claim 15, wherein the one or more processors are further configured to execute the instructions to:
store, in a conflict list of changed code, the changed code block; and
push, to the at least one of the plurality of terminals, the conflict list.

17. The computer program product of claim 15, wherein the attribute information further comprises a first author of the changed code block, wherein the one or more processors are further configured to execute the instructions to:
determine whether the first author is the same as a second author of the target code block; and
send, to a first target terminal, first warning information when the first author is different from the second author,
wherein the first target terminal is used by the first author, and
wherein the first warning information indicates that the target code block is modified.

18. The computer program product of claim 17, wherein the one or more processors are further configured to execute the instructions to:
determine, when the first author is different from the second author, whether the target code block overlaps a second location of a particular code block in a code analysis library, wherein the particular code block is for defining a function or a variable; and
send, when the target code block overlaps the second location, second warning information to a second target terminal in the distributed system,
wherein code compiled by the second target terminal comprises the function or the variable, and
wherein the second warning information indicates that the function or the variable changes.

19. The computer program product of claim 18, wherein the one or more processors are further configured to execute the instructions to:
analyze, when the target code block overlaps the second location, the changed code block to determine first key information of a first object defined by the changed code block;
determine second key information of a second object defined by the target code block, wherein the first object and the second object are functions or variables; and
compare the first key information with the second key information to determine difference information between the first key information and the second key information, and
wherein the second warning information further indicates the difference information.

20. The computer program product of claim 15, wherein the one or more processors are further configured to execute the instructions to obtain the attribute information of the changed code block that is from a collection agent module of the terminal.
